(19) United States
(12) Patent Application Publication
(10) Pub. No.: US 2025/0328879 A1
(43) Pub. Date: Oct. 23, 2025

(54) THE SYSTEM AND METHOD FOR PRELIMINARY PROCESSING AND VALIDATION OF DATA IN REAL TIME

(71) Applicant: NATIONAL PAYMENT CARD SYSTEM JOINT STOCK COMPANY, Moscow (RU)

(72) Inventors: Evgenii Georgievich SOLOVEV, Moscow (RU); Aleksandr Aleksandrovich POLUDNITSIN, Korsakov (RU); Konstantin Vyacheslavovich POPOVICH, Moscow (RU); Ivan Denisovich SHILAKIN, Moscow (RU)

(21) Appl. No.: 18/851,639

(22) PCT Filed: May 31, 2023
(86) PCT No.: PCT/RU2023/000157

§ 371 Date: Sep. 27, 2024

(30) Foreign Application Priority Data
May 31, 2022 (RU) 2022114657

(51) Int. Cl. G06Q 20/10; G06Q 20/38; G06Q 20/40; G06Q 20/42

(52) U.S. Cl. CPC G06Q 20/108; G06Q 20/381; G06Q 20/40; G06Q 20/42

(57) ABSTRACT

The invention relates to the financial industry, more specifically to systems and methods for automatic transaction processing for funds transfer between accounts in real time upon prior approval. The described methods and systems make it possible to perform interbank transfers in real time both within one country and for cross-border funds transfers. The technical result is an expansion of the scope of application, since the system and method use the existing payments acceptance and processing infrastructure, make it is possible to use any payment instrument for transferring funds both within one country and for cross-border transfers; an improvement of the transfer rate as the funds flow is not accompanied by approval and calculation of the exchange rate and fee; an improvement of the funds transfer reliability by decreasing the likelihood of payment refusal due to the fact that the funds flow is performed after preliminary preparation.

### FIELD OF THE INVENTION

The present group of inventions relates to the financial industry, more specifically to systems and methods for automatic transaction processing for funds transfer between accounts in real time upon prior approval.

### BACKGROUND OF THE INVENTION

Financial technologies are being rapidly developed, in particular the ones relating to cashless payments. Overlay services are among those.

Overlay services are software and hardware services developed to improve various consumer-friendly payment services (for individuals and legal entities). Overlay services improve security, simplify payments and, in some cases, make them smooth and frictionless. In financial industry overlay services may precede a payment or payments, follow a payment or payments, be used both before and after a payment or payments, as well as used irrespectively of any payment or payments. Any overlay service is applicable to any payment instrument and can be used for card payments (e.g. Mir card payments), payments via the Faster Payments System, payments with the use of digital rubles and other payment instruments.

As vulnerabilities of financial industry technologies are connected with risks, issues of developing such technologies while maintaining their reliability and the security of the data used in them remain relevant. Although existing technologies have proved to be effective, more advanced reliability mechanisms are required, in particular, mechanisms for reducing the probability of faults and failures during payment transactions, as well as mechanisms for protection against fraudulent transactions.

There are many technologies designed to support payment transactions both (1) within one country or in case of (2) cross-border funds transfers. At the same time, the known technologies are not universal, i.e. they are not configured for both of the above-mentioned transaction types, and do not improve security and reliability for all participants supporting payment transactions.

For example, the SWIFT system, a worldwide interbank system of financial telecommunication, has proven itself suitable for cross-border funds transfers. The system ensures the security and reliability of the messaging channel between financial organizations, such as the sender's bank and the recipient's bank, correspondent banks of the sender's bank and the recipient's bank. To make a transfer, the sender fills in the payment order details for using the SWIFT channel and generates an information order for the transfer of funds for the sender's bank. Then, the SWIFT system encodes the payment order and transmit it to the recipient's bank. As a result, the correspondent bank of the sending bank debits the required amount and transfers it to the correspondent bank of the recipient's bank. In this scheme, funds flow is not performed in real time. And there are also no provisions for preliminary checks and approvals of funds transfer terms immediately prior to the movement of funds between accounts, which means failures as a result of internal errors or blocking (e.g. sequestration) of the recipient's account cannot be ruled out.

Systems and methods for cross-border payment transactions in real time are also known in the art. The systems and methods describe the performance of a cross-border funds transfer in an existing payment acceptance infrastructure in which a sender in one country use a banking application on the sender's device connected to the sender's bank to initiate a transfer of funds to a recipient's account in another country. A cross-border transfer is performed via intermediary banks, and intermediary banks have interaction channels with the payment system of the country in which they are located and with each other. Funds transfer data includes the reference of the payment, the amount in the sender's currency, the exchange rate data on the date of the transaction and the amount after conversion into foreign currency.

As a result, cross-border payments are performed in real time without delays in performing cross-border payments due to processing errors and/or delays caused by one or more intermediary banks in the sender's country and/or recipient's country (patent application US 2021182810; G06Q20/02, G06Q20/08; published on 17 Jun. 2021).

The disadvantages of this invention include the high probability of errors occurring during the transaction, since all the necessary preliminary checks are not performed in real time before the payment is made. Accordingly, for example, if the sender selected the wrong recipient, the error will be discovered only after the funds are credited to the recipient. The disadvantages also include the fact that the recipient of funds cannot be identified in advance without prior approval, which means funds can be credited without any checks established by law, e.g. under the AML/CTF system (anti-money laundering and counter-terrorism financing). Thus, the disadvantage is that the systems and methods do not provide the technical ability to perform preliminary checks and prepare for payment before the funds transfer, which means there is a possibility of errors and transactions violating regulatory requirements. Other examples of incidents may include an incorrectly entered or invalid account of the funds recipient. The systems and methods described in patent application US 2021182810 are not configured to pre-generate a payment order containing a reliable final transfer amount, taking into account fees and conversion rates. The described technology is not universal, it is configured only to ensure cross-border funds transfers without prior check of their conditions.

Another analogue of the technical solution is a method and system for funds transfer from one account to another, which, after the payment transaction initiation, allow performing settlement between the accounts of the sender and recipient of funds in the same country in real time, and the transfer is performed in the existing infrastructure of payments processing and acceptance.

As a result, a high velocity of funds transfers is ensured while maintaining their reliability (RF patent 2761419; G06F 17/00, G06Q 20/02; published on 8 Dec. 2021).

The disadvantages of the invention are its narrow scope of application, since the described system and method are only applicable for payment transactions within one country and are not configured to ensure cross-border transactions. The disadvantages also include the fact that the payment transaction and its checks are performed simultaneously, which does not exclude the occurrence of errors and failures during settlements (funds flow), which as a result reduces the speed of the funds transfer.

Thus, currently there is no single universal technology for online funds transfers both within one country and for cross-border funds transfers while ensuring high reliability and security of such transfers.

### SUMMARY OF THE INVENTION

The technical problem at which the invention is aimed is the creation of a system and method for performing funds transfers in real time both within one country and between different countries, for which the reliability of the details (“transparency” of payment terms) and better identification of the funds recipient by the sender will be ensured.

The technical result is an expansion of the scope of application, since the system and method use the existing payments acceptance and processing infrastructure, make it is possible to use any payment instrument for transferring funds both within one country and for cross-border transfers; acceleration of the transfer rate as the funds flow without any approval and calculation of the exchange rate and fee; improvement of the funds transfer reliability by decreasing the likelihood of payment refusal due to the fact that the funds flow after preliminary preparation.

The specified technical result is achieved in systems and methods that are described in more detail below.

The following terms will be used below: Sender's bank is at least one computing device of a credit organization serving the customer, being the sender, as defined by the standards, from whose correspondent account funds must be debited when transferring funds by order of the customer.

Recipient's bank is at least one computing device of a credit organization serving the recipient as defined by the standards, to whose correspondent account funds must be credited when transferring funds in favor of the recipient of funds.

Intermediary bank is at least one computing device of a credit organization that has communication channels with computing devices of other credit organizations, such as intermediary banks, processors (e.g., payment systems), sender's bank and recipient's bank, etc. The intermediary bank is configured to perform funds transfers between accounts in the same currency and in different currencies between accounts of an individual including via the SWIFT or SPFS (the Financial Messaging System) and/or other settlement systems.

At least one of the banks (the sender's bank, the recipient's bank, or the intermediary bank) is configured to determine the sell rate, determine the buy rate and convert amounts according to the established rules. To perform its functions, the bank carrying out the conversion is configured to access at least one database via communication channels to retrieve the specified buy rate, sell rate, and rules for converting amounts. When accessing two or more databases, the bank carrying out the conversion is configured to determine the terms of buy/sell for certain transactions. Databases herein shall mean, including, but not limited to, currency exchanges, e.g., Moscow Exchange. The bank carrying out the conversion accesses the database or databases to determine the rate once at a certain time (for example, once a day) and/or upon the occurrence of certain events in which the currency rate fluctuates significantly.

Processor (a provider of electronic payments processing) is at least one computing device that has communication channels with computing devices of various credit organizations, such as banks, a settlement system (software and hardware complex of the organization meeting the requirements of banks, for example, the Central Bank of the Russian Federation), and others. The processor herein also acts as an information technology intermediary at the stage of the payment order generation and approval. The processor, among other things, ensures the reception and transmission of messages between participants in the systems and methods, determination of the recipient's bank by the recipient's identifier, validation of message data, assigning an electronic payment processing identifier to a message, linking of the mentioned identifier and the data contained in the message, storage of the identifier and data combination in a database, provision of the data contained in the message on the basis of the said identifier upon request.

The processor is configured to perform both the functions of a data flow provider and the functions of an operational and payment clearing center. As an example, the processor may be a payment system. Payment system is a credit organization having a software component for performing various financial transactions based on rules and standards, such as transferring funds, including electronic ones, exchanging messages, accepting funds transfer orders for execution, payment clearing functions center and clearing center. Performing functions of a payment clearing center and settlement center. The payment system is also configured to generate and send to the settlement system requirements to debit funds from the sender's bank account and credit funds to the recipient's bank account, and then send a response from the settlement system to the sender's bank and to the recipient's bank.

Data flow is a transfer of a set of messages forming an integral logical unit between computing devices of credit organizations to receive data on the transfer, including, but not limited to, data on the payer, data on the payer's bank, data on the payment system, data on the intermediary bank, data on the recipient, data on the recipient's bank, the transfer amount and the fees that are charged by system participants in the event of a funds transfer.

Sender is an owner of a bank account from which it is possible to transfer funds if data flow and sender's order processing is successful.

Recipient is an owner of a bank account, identified in the data flow, to which it is possible to transfer funds if data flow and sender's order processing is successful.

Sender's device/receiver's device is a personal communication device used when performing a transaction both when processing the data flow and when making a payment. The sender's device and the recipient's device may include, but are not limited to, any devices with a user interface that provide the ability to perform a transaction according to a system or method, as well as to exchange data and receive information about the data flow and/or payment transaction processing. For example, a personal device such as a mobile phone, computer, etc., or a public device such as a terminal or ATM. What these devices have in common is the need for the sender to be preliminarily authenticated by their sender's bank in the interface of that device. The sender and recipient can be an individual, a legal entity or a government agency.

Computing devices of credit organizations exchange messages with their customers and among themselves. To optimize the processes of data exchange between parties, international standards have been developed (such as, for example, international standards ISO 20022, ISO 8583), or standards for specific payment systems based on international ones, which contain clear definitions of information and data formats (field length, codes, sets of characters) that parties can exchange. The standard infrastructure comprises devices of the sender and recipient, banks (sender's bank, recipient's bank and in some cases an intermediary bank), a processor (computing device of the payment system (PS); for example, this is applicable to Mir Payment System or the Faster Payments System, or SEPA, or SWIFT, or any other international or local payment system) and a settlement system (software and hardware complex of the organization that fulfills the payment requirements of banks, i.e., interbank settlements, for example, the Central Bank of the Russian Federation). The described systems and methods are configured to use communication channels to exchange such messages among themselves.

Recipient/Sender ID is a well-known social identifier such as a phone number, email address, or other identifiers pre-registered with the bank where the recipient/sender has an account. The recipient/sender must be securely authenticated by their bank. In this case, the bank can assign these identifiers to at least one bank account selected by the customer.

Electronic payment processing identifier is a unique identifier assigned by the processor to a message to indicate that the performed operation is an operation of preliminary approval of a payment order prior to the funds transfer in real time based on the approved payment order, as well as to enable the following electronic payment processing schemes. The processor determines the need to assign such an identifier based on the message type, namely the protocol, i.e. language of communication with other system components and message entry points (endpoints). For example, parties can use the REST (Representational State Transfer) architectural style, which implements APIs for messages transmitting and processing. Examples of identifier: “pre-validation” or “LookUp” or another value that is placed in an email data element, such as a “Settlement Services” data element.

Message enrichment is the process of enriching messages with data required to conduct operations before sending those messages to the recipient. The computing devices used for the messages enrichment are pre-configured to process messages automatically.

Below, the invention is detailed in drawings.

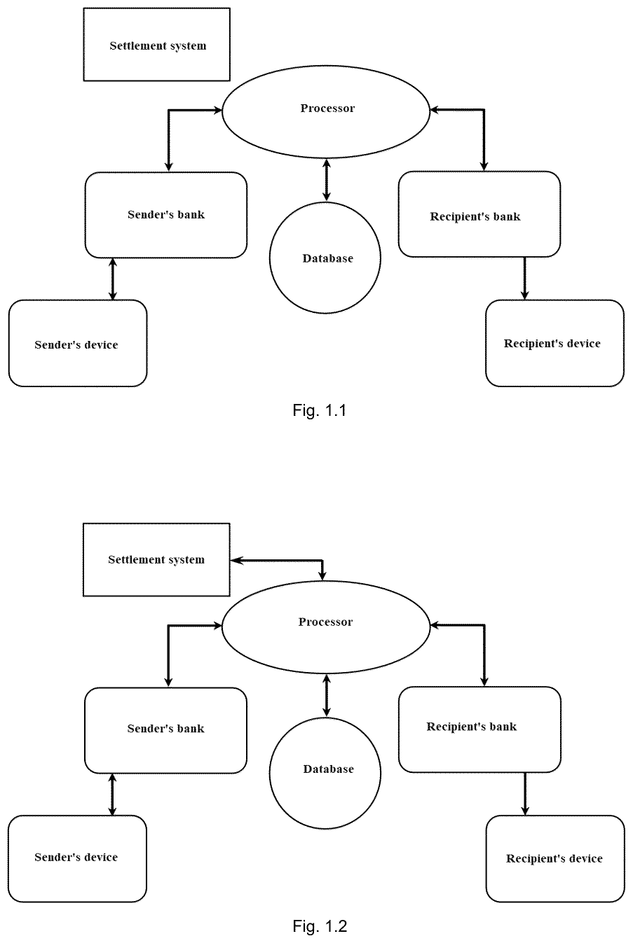

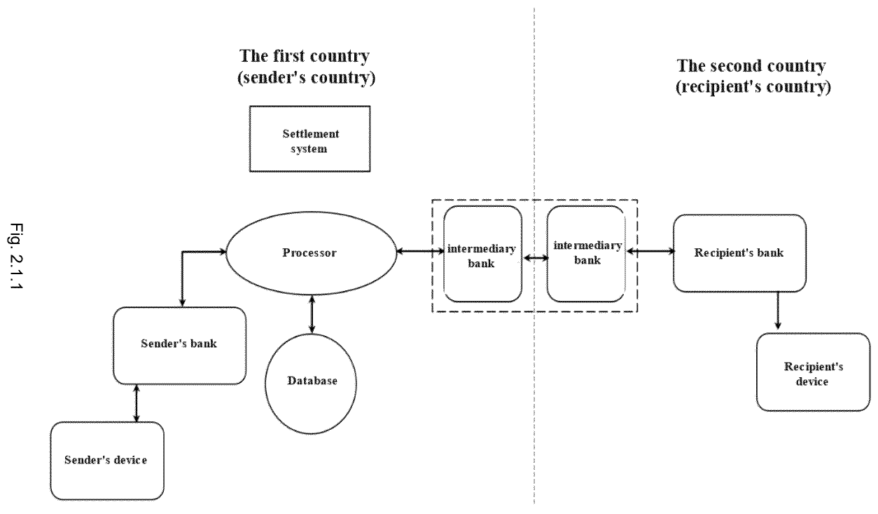

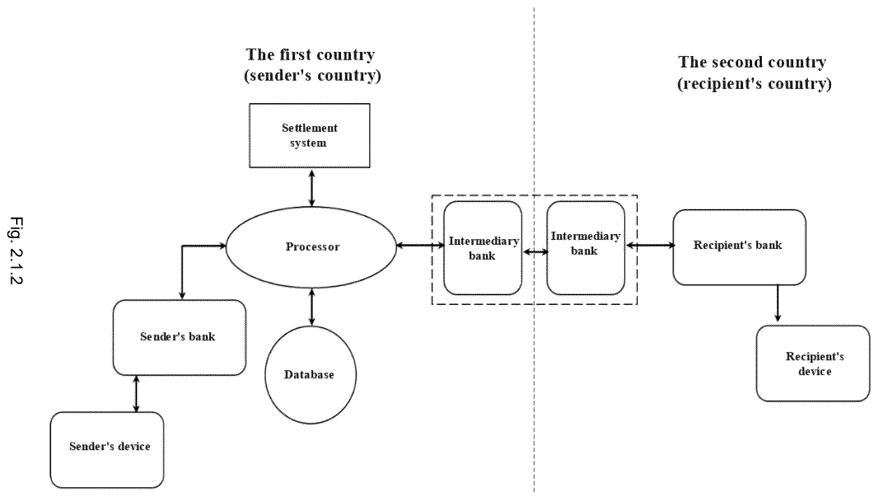

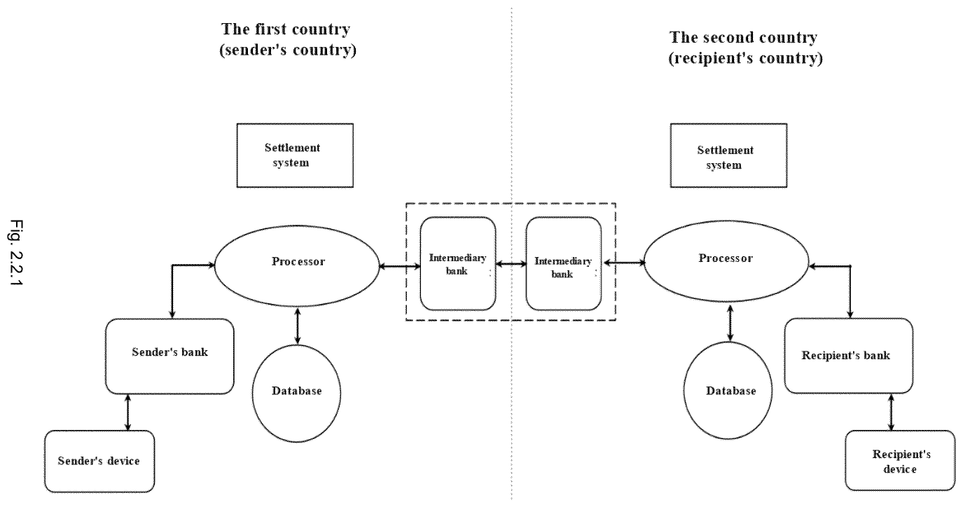

FIG. 1.1—System for processing electronic payments according to the first embodiment—data flow.

FIG. 1.2—System for processing electronic payments according to the first embodiment—transfer of funds.

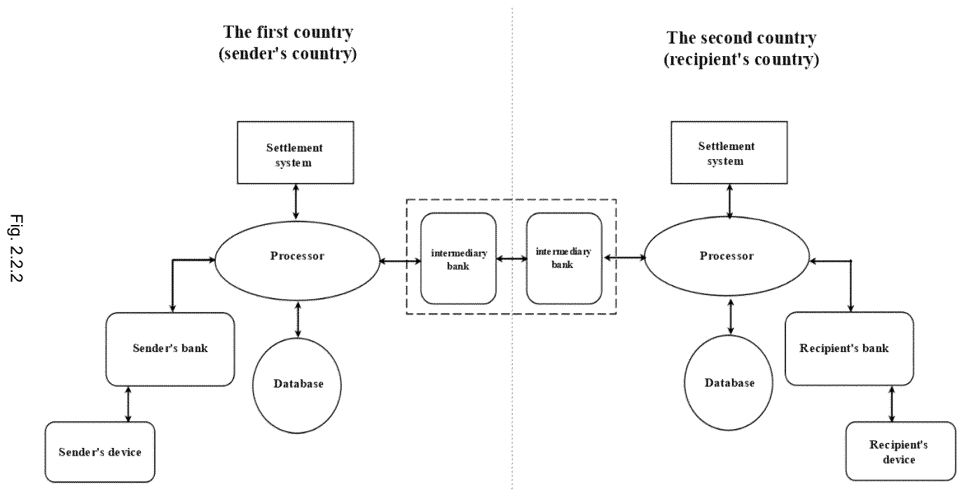

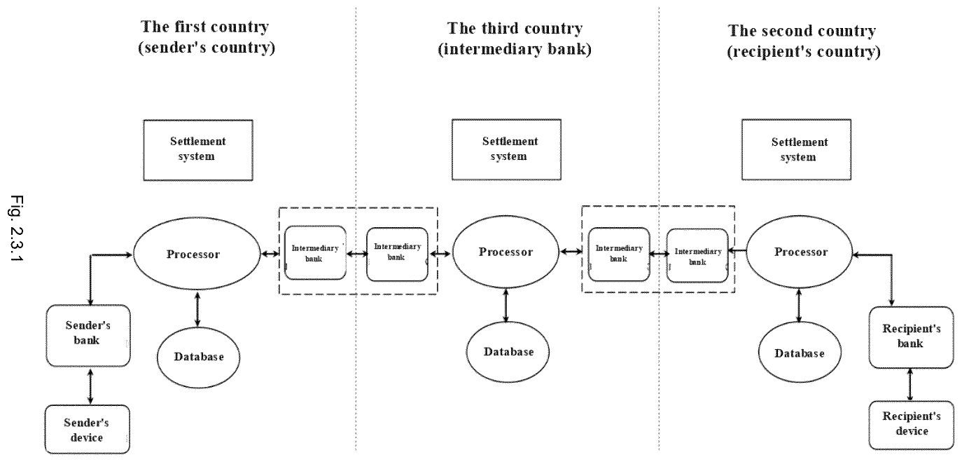

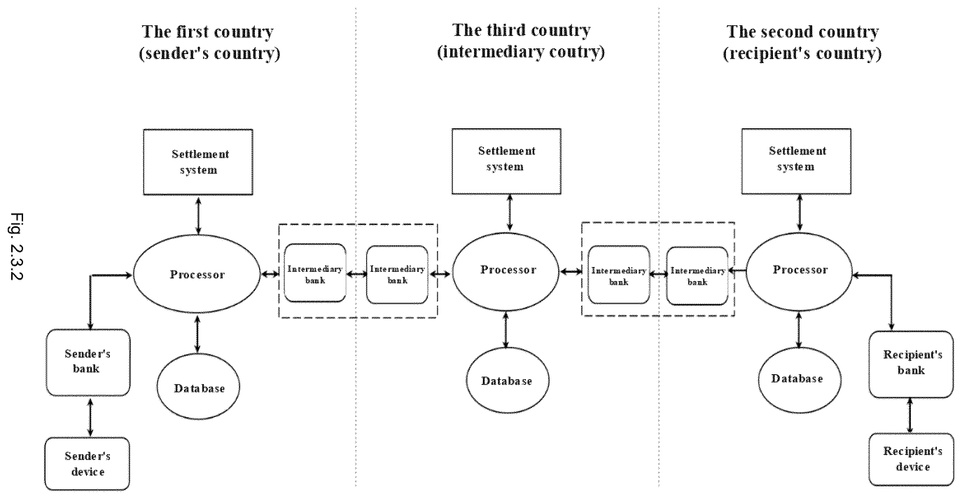

FIG. 2.1.1—System for processing electronic payments according to the second embodiment without a processor of the second country (recipient's country)—data flow.

FIG. 2.1.2—System for processing electronic payments according to the second embodiment without a processor of the second country (recipient's country)—transfer of funds.

FIG. 2.2.1—System for processing electronic payments according to the second embodiment with a processor of the second country (recipient's country)—data flow.

FIG. 2.2.2—System for processing electronic payments according to the second embodiment with a processor of the second country (recipient's country)—transfer of funds.

FIG. 2.3.1—System for processing electronic payments according to the second embodiment with a third country (intermediary country/transit country)—data flow.

FIG. 2.3.2—System for processing electronic payments according to the second embodiment with an intermediary country/transit country—transfer of funds.

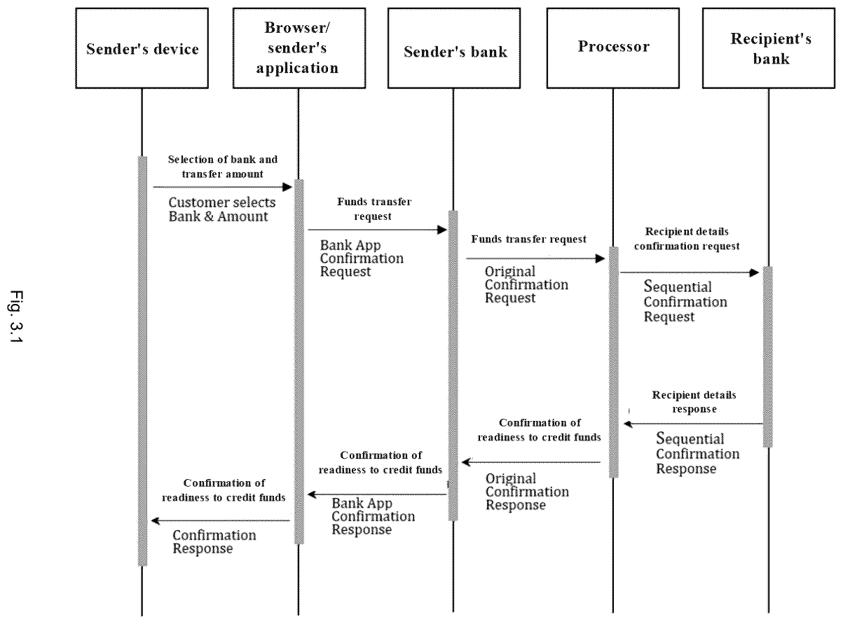

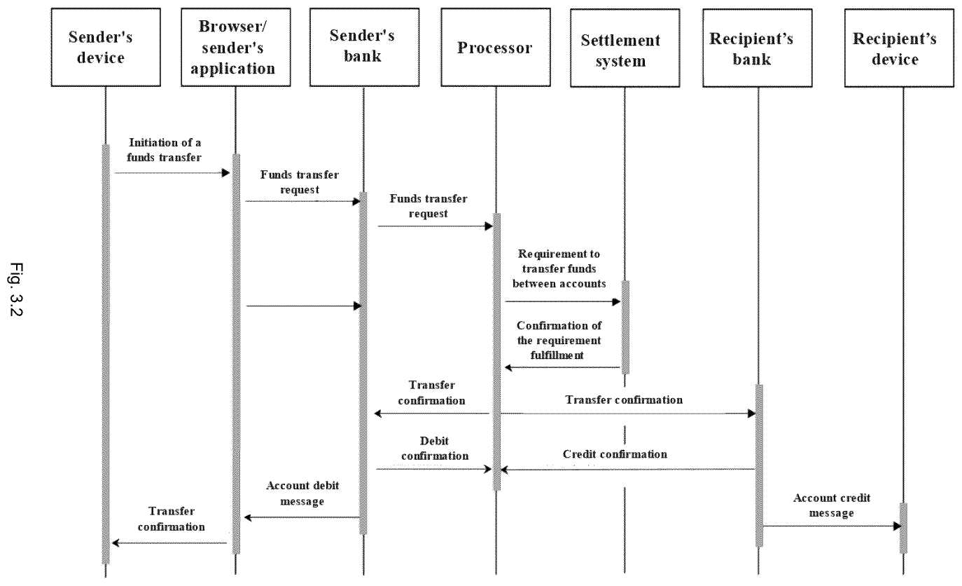

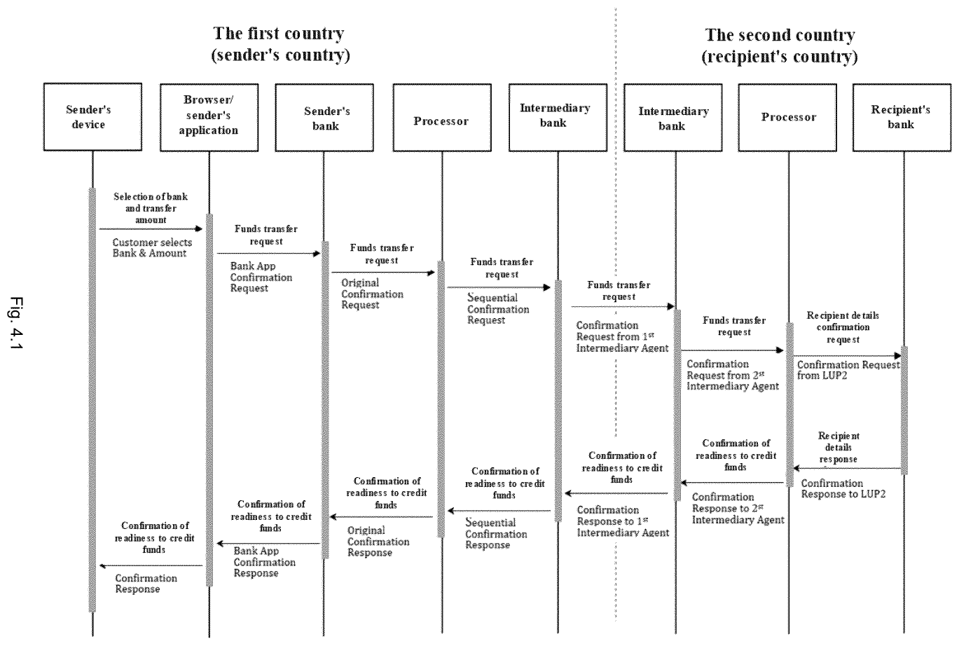

FIG. 3.1—Method for processing electronic payments according to the first embodiment—data flow.

FIG. 3.2—Method for processing electronic payments according to the first embodiment—transfer of funds.

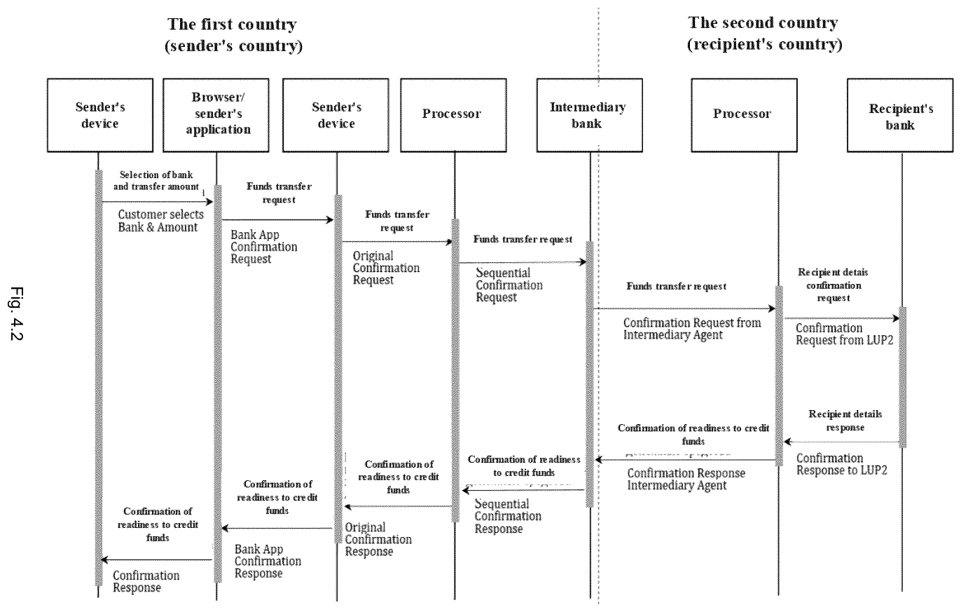

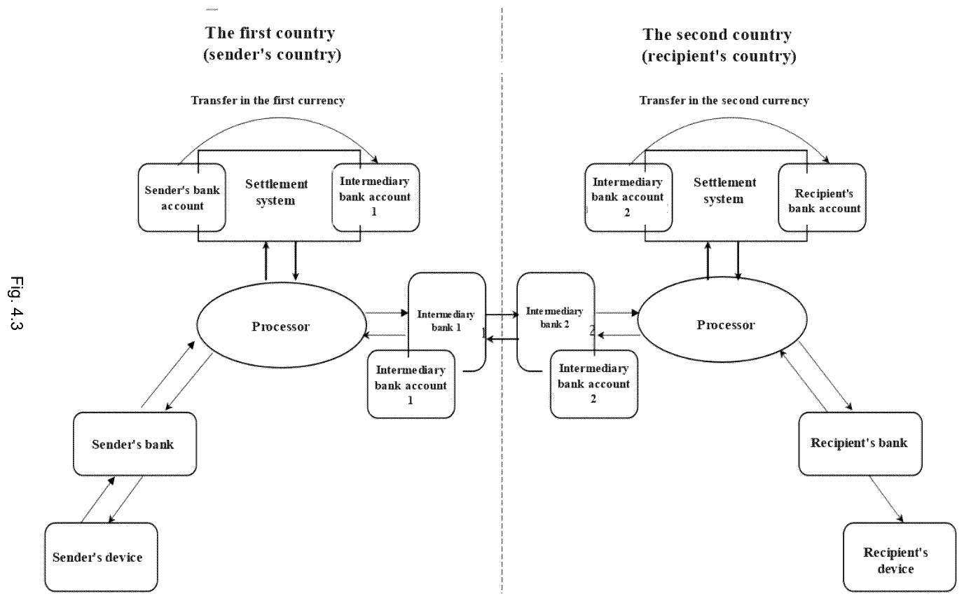

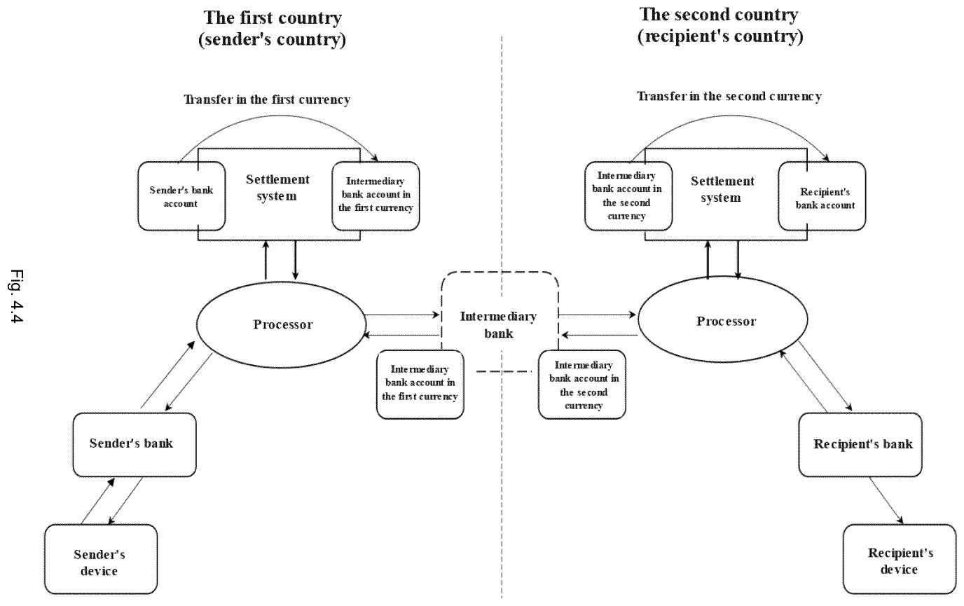

FIG. 4.1—Method for processing electronic payments according to the second embodiment with two intermediary banks—data flow.

FIG. 4.2—Method for processing electronic payments according to the second embodiment with one intermediary bank—data flow.

FIG. 4.3—Method for processing electronic payments according to the second embodiment with two intermediary banks—transfer of funds.

FIG. 4.4—Method for processing electronic payments according to the second embodiment with one intermediary bank—transfer of funds.

### DETAILED DESCRIPTION OF THE INVENTION

The presented invention ensures the exchange of messages within the data flow during which all the necessary data is prepared and approved, specifically: data on the transaction and participants is collected and a payment order is approved; sender, recipient and payment data is verified and included in the data flow; this data, including the rate and/or fees, is recorded. Preparatory actions are performed immediately upon request, i.e., in real time. One of the features of this technology is that preparation is performed separately from the transfer of funds, and not together, like all known analogues. This data flow forms a so-called data loop, as messages flow forward and backward.

Preliminary approval of data as part of a separate data flow allows the sender to familiarize themself with the reliable and approved terms of the transfer immediately prior to sending funds in order to confirm the transfer or refuse it. Also, preparatory actions will allow establishing in advance the technical capability to credit funds by checking the status of the recipient's account, recognize the recipient in order to avoid fraudulent transactions, identify and correct errors before transferring funds, which will significantly reduce the likelihood of errors and failures, and thereby ensure uninterrupted performance of funds transfers using the correct details.

Below are descriptions of drawings provided as examples and to illustrate embodiments of the invention.

FIG. 1.1 depicts a system in which the preparation and approval of data and terms for transferring funds are implemented in the data flow within one country. FIG. 1.2 depicts the connection with the settlement system, which ensures the transfer of funds after approval of data and terms of the said transfer.

FIG. 2.1.1 depicts a system in which the preparation and approval of the terms and data of funds transfer are implemented in the data flow for transfers from the first country to the second country. It is understood that the system may be implemented without the processor of the first country and/or without the processor of the second country.

FIG. 2.1.2 depicts the connection with settlement systems that ensure the transfer of funds after approval of the transfer data and terms.

FIG. 2.2.1 depicts a system in which data flow is implemented, with both the processor of the first country and the processor of the second country participating in the system.

FIG. 2.2.2 depicts the connection with settlement systems that ensure the transfer of funds after approval of the transfer data and terms.

FIG. 2.3.1 depicts a system in which the preparation and approval of the funds transfer data and terms are implemented in the data flow for transfers from the first country to the second country, with involvement of computing devices of the intermediary country.

FIG. 2.3.2 depicts the connection with settlement systems that ensure the funds transfer after approval of the funds transfer data and terms from the first country to the second country.

To initiate the electronic payments processing methods, the sender initiates the funds transfer via the user interface in the payer's bank on the device (in a browser on the web page of their bank in their personal account, or in a browser on the web page for payment, or in the user interface on the sender's device, or on a public device—a terminal or ATM).

FIG. 3.1 depicts a method for processing messages within one country.

The method is implemented as follows for example.

A recipient's social identifier (for example, a phone number) is entered on the sender's device and the transfer amount is specified, or a machine-readable tag containing the recipient's identifier and the transfer amount is entered.

After that, a funds transfer request is sent, for example, in the “Bank App Confirmation Request” message for a request from a mobile application installed on the sender's mobile device. The same is applicable for sender requests from other devices.

The sender's bank receives the message, checks the data, adds the sender's bank identifier and other data (optional) to the data element and sends it in the “Original Confirmation Request” to the processor (for example, to the Mir computing device).

The processor checks the sender's bank registration in the system, assigns the “LookUp” electronic payment processing identifier to the message, determines the recipient and sends the data to the recipient's bank in the “Sequential Confirmation Request” message format. The recipient is determined by extracting the combination of the recipient's identifier and the recipient's bank from the database. According to one of the embodiments, the data from the “Sequential Confirmation Request” message with the electronic payment processing identifier “LookUp” is saved into the database. This step allows avoiding the transfer of the entire data array in the future, and allows transferring only the message processing identifier and providing the data upon request. It is also possible to provide data upon request after the funds have been transferred. This step can be applied not only for this transfer option, but also for all embodiments of this technology.

The recipient's bank also checks data, supplements data with the recipient's bank identifier and confirmation of readiness to credit funds, as well as a verification phrase (PAM, Personal Assurance Message, for example, the recipient's full name). The verification phrase is subsequently used to demonstrate the recipient's data to the sender for verification.

Then, a response in a message in the “Sequential Confirmation Response” format is received from the recipient's bank, which is sent to the processor, and then a response in a message in the “Original Confirmation Response” format is sent from the processor to the sender's bank. The response contains the amount to be credited, confirmation of readiness for credit, data of the sender's bank, data of the recipient's bank, data of the sender and data of the recipient. Accordingly, the result of the operation is a preliminary approval of the payment order.

FIG. 3.2. depicts the method for the funds transfer within one country after the preliminary approval of a payment order.

Once the sender has received the approved payment order in the user interface on the device, they can initiate a funds transfer and thus indicate the sender's consent to such a transfer.

For example, the sender initiates a transfer in the user interface of a mobile application. Then, after that, the mobile application sends the “CreditTransferRequiest” message to the sender's bank with a funds transfer request, which includes at least a confirmation of the recipient's bank readiness to credit the payment and the payment amount. The sender's bank receives such a message, determines that it refers to a pre-approved payment order, and then, without repeated checks, forwards the message to the processor (for the purposes of this example, to the Mir payment system). Based on the funds transfer request, the processor generates a “CreditTransferResponseFromIPS” message and sends it to the settlement system with a requirement to debit funds from the sender's bank account and credit them to the recipient's bank account. The settlement system fulfills the requirement and then sends the “CreditTransferResponseToIPS” message to the processor confirming the fulfillment of the requirement, and then sends the “AcknowledgmentToBenificiaryBank” message to the sender's bank and the “AcknowledgmentToInitiatorBank” message to the recipient's bank confirming the fulfillment of the requirement. After that, the sender's bank and the recipient's bank send “StatusReportToInitiator” and “StatusReportToBenificiary” messages to the sender and recipient with notification of funds debiting and funds crediting, respectively, and a confirmation of the sending of messages is sent to the processor in response.

FIG. 4.1 depicts an embodiment of the method according to which preparation and approval is formed in the data flow for a cross-border transfer, and two intermediary banks participate in this scheme. In this case, the data flow includes the messages described below.

The transfer amount and the recipient's identifier are entered on the sender's device, or this device reads a machine-readable tag containing the transfer amount and the recipient's identifier, represented by a social identifier, or an account number, or a bank card number, or a bank card token number, or a virtual payment address. Optionally, at least the country of the recipient's bank, the name of the recipient's bank, the payer's identifier, and the payment reference may be specified.

For transfers from the first country to the second country, it is typical that, when specifying the amount, it is required to select the amount to be debited from the sender in the currency of the sender's bank and the currency of the sender's bank, or the amount to be credited to the recipient in the currency of the recipient's bank and the currency of the recipient's bank.

A funds transfer request is formed, for example, in a mobile application installed on the sender's mobile device; the request data is placed in the “Bank App Confirmation Request” message.

The sender's bank receives the data, validates it and supplements it with the sender's bank identifier, the sender's bank account number and optionally additional data (full name of the sender, unique message number, date and time of sending, name of the sender's bank, etc.), and then sends the data in the “Original Confirmation Request” message to the processor of the sending country (for example, to the computing device of the electronic payment processing provider).

After that, the processor checks the sender's bank identifier and the fact of its registration in the system, generates a “pre-validation” electronic payment processing identifier, supplements the received data with the mentioned identifier, supplements the data with the account number of the intermediary bank of the first country and its identifier, and then sends a message in the “Sequential Confirmation Request” format to the intermediary bank of the first country.

Then, the data is sequentially transmitted from the intermediary bank of the second country in the “Confirmation Request from 1st Intermediary Agent” message.

The intermediary bank of the first country or the intermediary bank of the second country determines the buy rate or sell rate of the amount in the currency of the sender's bank to convert it into the amount in the currency of the recipient's bank (or vice versa) and supplements the message data with information about the rate. It is decided in advance which intermediary bank determines the buy/sell rate. This could be, for example, one of the default intermediary banks or the intermediary bank in whose country a funds transfer request was initiated.

The data is then sent from the intermediary bank of the second country to the processor of the second country in the “Confirmation Request from 2st Intermediary Agent” message.

Next, the processor of the second country (recipient's country) and the recipient's bank exchange messages; as a result, the processor of the second country sends a message in the “Confirmation Request from LUP2” format, including the account number of the intermediary bank of the second country.

The recipient's bank confirms consent to credit funds to the recipient's account, supplements the message with the recipient's bank data, recipient data and PAM, and then sends a response in a message in the “Confirmation Response to LUP2” format and then the messages are transmitted to the sender's device back, as shown in FIG. 4.1.

The processor of the first country and/or the processor of the second country may be both a national payment system computing device and an international payment system computing device.

FIG. 4.2 depicts an embodiment of the method in which preparation and approval are formed in the data flow for a transfer from the first country to the second country in a scheme with one intermediary bank. This embodiment differs from the previous one, as a message in the “Sequential Confirmation Request” format is sent from the processor to the intermediary bank. The intermediary bank defines the buy rate or sell rate of an amount in the currency of the sender's bank to convert it into an amount in the currency of the recipient's bank (or vice versa) and supplements the message data with the information about the rate. Then the transfer data, supplemented by the intermediary bank, is transmitted in the “Confirmation Request from Intermediary Agent” message to the processor of the second country.

Upon completion of the messages exchange within the data flow, which, as mentioned above, forms a data loop (the messages first go from the sender to the recipient and then back), the sender receives on his mobile device, or on a web page in a browser, or on a public device, comprehensive reliable data on the transfer, as well as consent from the recipient's bank to credit funds confirming that the account is valid, as well as consent from the recipient's bank to credit funds, confirming that the account is valid and not frozen, as well as confirmation (such as, for example, PAM (Personal Assurance Message) to display it to the sender on the sender's device to increase their confidence in correctness of the selected recipient.

As a result, before the funds transfer, comprehensive data for the transfer of funds is prepared for all parties involved. The data must include:
data on the sender and his account, data on the sender's bank generated and provided by the sender's bank;
data on the recipient, data on the recipient's bank generated and provided by the recipient's bank;
the transfer amount with consideration of the transaction data (fees and conversion rate) consistently generated by all participants in the preparation of the transfer.

As a result, the total amount is sent to the sender's device, taking into account fees and the conversion rate.

Also, the initiation of a funds transfer can be carried out at the request of the recipient of the funds. In this case, the recipient provides the approved payment order details to initiate the funds transfer. This data includes the name/identifier of the recipient's bank, the payment order identifier and optionally other data such as the transfer amount. The data can be presented in any machine-readable format, such as a link, QR code, etc.

In response, the sender, at his discretion, can send a requirement to the settlement system to debit funds from the sender's account and credit funds to the recipient's account. After the sender has confirmed his intention to transfer funds using the data generated in the previous step, the payment process starts.

FIG. 4.3 depicts the method according to which funds are transferred from the first country to the second country with two intermediary banks after preliminary approval of the payment order. To initiate a funds transfer based on the results of the messages exchange within the data flow, a message is sent from the sender's device containing the approved payment order and the payment order identifier generated in the previous step (within the data flow). The approved payment order comprises the payment order identifier generated in the previous step (as part of the data flow) and the payment order data: the transfer amount in the sender's currency (the first currency) or in the currency of the transfer recipient's country or in another currency (the second currency); recipient's identifier, for example, in the form of the recipient's bank card number, social identifier such as mobile phone number, email address, etc.; additionally, the name of the recipient's bank, the country of the recipient's bank (optional) and other data can be indicated.

The said message is transmitted sequentially to the sender's bank, then to the processor of the first country, from which a requirement to transfer funds in the first currency from the sender's bank account to the account of the intermediary bank of the first country is sent to the settlement system of the first country; and then confirmation of the requirement fulfillment is received.

The processor of the first country then sends the message comprising confirmation of the requirement fulfillment to the intermediary bank of the first country and then to the intermediary bank of the second country.

One of the intermediary banks the amount of funds is converted from the first currency to the second currency according to the previously approved rate specified in the payment order. To carry out mutual settlements, an account of the intermediary bank of the second country is opened with the intermediary bank of the first country (or an account of the intermediary bank of the second country is opened with the intermediary bank of the first country). At least one computing device of the intermediary bank extracts payment order data from the message and starts a procedure that allows funds to be converted from the first currency to the second currency.

Then, the data from the intermediary bank of the second country is sent to the processor of the second country, which forms a requirement for the transfer of funds from the account of the intermediary bank of the second country to the account of the recipient's bank of the second country in the second currency; after that it receives a response confirming the requirement fulfillment. As a result, according to a previously approved payment order, a funds transfer is performed from the first country to the second country.

FIG. 4.4 depicts the method according to which funds are transferred from the first country to the second country with one intermediary bank after preliminary approval of the payment order. The method is carried out similarly to the method with two intermediary banks. The difference is that the amount of funds is converted from the first currency to the second currency according to the previously approved rate in one intermediary bank. To perform settlements, an account in the first currency and an account in the second currency are opened with the intermediary bank. The intermediary bank's computing device extracts the payment order data from the message and starts a procedure that allows funds to be converted from the first currency to the second currency between the specified intermediary bank accounts.

Processing of electronic payments in which computing devices of a third country are involved, is carried out in a similar way. In this case, computing devices perform the functions described above, and the processing of electronic payments according to this embodiment differs in that it includes an additional step both at the processing stage within the data flow and during the transfer of funds. Thus, the processing of electronic payments can be carried out with the participation of one, two or more countries for transfers via intermediary countries.

Also, this invention provides for processing of electronic payments without a processor of the first country and/or without a processor of the second country. In these embodiments, the transfer of funds is also carried out after prior approval. In this case, the processing and transmission of messages is carried out in accordance with the described functionality by banks (the sender's bank, at least one intermediary bank and the recipient's bank), which have communication channels and are configured to implement the systems and methods. The intermediary bank is also configured to convert funds from the first currency to the second currency between the sender's bank and at least one intermediary bank or the at least one intermediary bank and the recipient's bank. The movement of funds between the intermediary bank and the sender's bank/recipient's bank is carried out via interbank transfer by any known methods.

The sequential generation of payment data can be accompanied (optionally) by the transmission of a control value of the operation to monitor data integrity. Each of the parties involved in messages processing (computer systems of banks, payment systems, settlement systems) is configured to ensure monitoring of data integrity in the transmitted data. To do this, an operation control value (OCV) is placed in the transmitted messages, for example, by supplementing the array in a special block (for example, in the “risk” block) with a set of independently generated values. Any participant can check the integrity by checking the value of previously generated OCVs and validating the OCVs calculated and included in the data flow. The procedure described above further increases the security of message processing in terms of maintaining data integrity when carrying out various operations.

According to one of the embodiments, the initiation of a funds transfer is carried out, for example, but not limited to, via the Faster Payments System (SBP). To perform such a transfer, banks connect to the Faster Payments System. The initiator of the funds transfer can be the sender or the recipient of funds. The sender enters the transfer data or reads the transfer data prepared by the recipient and then initiates the payment in their mobile application on a mobile device or on a web page in a browser. The peculiarity of transferring funds via SBP is that, for each payment transaction, funds are transferred by the settlement system during the payment. To do this, a request is sent from the sender's bank to the processor (for example, OPCC SBP—the operational clearing center of the Faster Payments System), which, in turn, generates and sends to the settlement system a requirement to debit funds from the payer's bank account and credit funds to recipient's bank account. To transfer funds from the sender's account from the first country to the recipient's account from the second country (cross-border transfer via SBP), a requirement to debit funds from the payer's bank account and credit funds to the account of the intermediary bank of the first country is generated by the processor of the first country and sent to the settlement system. The settlement system can be represented, for example, by at least one computing device of the Central Bank of the Russian Federation or the Central Bank of another country. The settlement system fulfills the requirement in real time or in a deferred mode (during the predetermined time) and sends a response to the payment system with a message that the requirement has been fulfilled. Finally, the processor sends notifications of funds debiting and crediting to banks in accordance with the fulfilled requirement. FIGS. 4.3 and 4.4 depict that when transferring funds from the first country to the second country, as in the case with the settlement system of the sender's country, a transaction of funds transfer between accounts is also performed in the settlement system of the recipient's country upon request generated by the processor of the second country.

According to the described systems and methods, the settlement systems of two countries involved in the transfer of funds can narrow a transfer from the first country to the second country (cross-border transfer) down to two interbank transfers (one transfer in each of the settlement systems). Thus, a transfer of only one amount in each of the settlement systems of these countries (one amount in the currency of the first country and another amount in the currency of the second country) makes it possible to take into account all fees and conversion rates and check the funds transfer data, as well as check the correctness of calculations using checksums.

The methods described above can be carried out using the described electronic payment processing systems. The described systems and methods are used both for transfers within one country and for transfers from the first country to the second country (cross-border transfers), including for transfers via an intermediary country using the mechanisms of urgent transfers, non-urgent transfers and transfers via the Faster Payments System.

The advantages of the system and method are acceleration and improvement of reliability of funds transfers, reduction of the likelihood of payment refusal due to the fact that funds are moved after preliminary preparation, no approval and calculation of the rate and fees are required; the invention enables a wide range of application, since the system and method use the existing infrastructure for payments acceptance and processing, and make it possible to use any payment instrument for transferring funds both within one country and for cross-border transfers.

1. A system for data pre-processing and validating in real time separately and before the electronic payment transaction, comprising:
the sender's device,
the sender's bank computing device, the recipient's bank
computing device, a processor
having communication channels for messaging,
wherein
the sender's device is configured to initiate the data flow, in real time separately and before the payment transaction, by sending the message containing the recipient's identifier and the transfer amount to the computing device of the sender's bank, and receive a response from the computing device of the sender's bank;
the computing device of the sender's bank is configured to, in real time separately and before the payment transaction, receive a message from the sender's device, check and validate the message data, enrich the message with data from the sender's bank, transmit the enriched message to the processor and receive a response from processor;
the processor is configured to, in real time separately and before the payment transaction, receive the enriched message, determine the recipient's bank using the recipient's identifier, transmit the enriched message to the computing device of the recipient's bank, receive a response from the computing device of the recipient's bank and send the response to computing device of the sender's bank;
the computing device of the recipient's bank is configured, in real time separately and before the electronic payment transaction, to receive an enriched message, enrich it with data of the recipient, the recipient's bank, confirmation of readiness of the recipient's bank to credit funds, and send the enriched message to the processor in response,
wherein the processor is configured to, in real time, separately and before the payment transaction;
generate an electronic payment processing identifier that uniquely identifies the message, and
send to the sender's device, via the computing device of the sender's bank, a message with a pre-approved payment order for an electronic payment transaction and an electronic payment processing identifier for their subsequent use when performing an electronic payment transaction.

2. The system according to claim 1, wherein the computing device of the sender's bank is configured to receive from the sender's device a response to the enriched message comprising at least the payment amount, confirmation of readiness of the recipient's bank to credit funds, and an electronic payment processing identifier indicating that the funds transfer is approved, and to send this data to the processor; and the processor is configured to send to the settlement system a requirement to debit funds from the sender's bank account and credit funds to the recipient's bank account, receive confirmation from the settlement system that the requirement has been fulfilled, and send the above-mentioned confirmation to the computing device of the sender's bank and to the computing device of the recipient's bank.

3. A system for data pre-processing and validating in real time separately and before the electronic payment transaction, comprising a sender's device,
a computing device of the sender's bank,
a computing device of the recipient's bank,
a processor of the first country,
a processor of the second country,
and at least one computing device of the intermediary bank,
having communication channels for messaging, wherein
the sender's device is configured to initiate the data flow, in real time separately and before the payment transaction, by sending the message containing the recipient's identifier and the transfer amount to the computing device of the sender's bank, and receive a response to the message;
the computing device of the sender's bank is configured to, in real time separately and before the payment transaction, receive a message from the sender's device, check and validate the message data, enrich the message with data from the sender's bank, transmit the enriched message to the processor of the first country;
the processor of the first country is configured to, in real time separately and before the payment transaction, receive the enriched message and assign an electronic payment processing identifier to it, determine the recipient's bank by the recipient's identifier, transmit the enriched message with an electronic payment processing identifier to the computing device of the intermediary bank, receive a response from the computing device of the intermediary bank and send the response to the sender's bank;
the computing device of the intermediary bank is configured to, in real time separately and before the payment transaction, receive, check and validate data in the enriched message, determine the buy rate or sell rate of the amount in the first currency to convert it into the amount in the second currency to supplement the message with the value of the amount in the first currency with the amount in the second currency and transmit the message from the intermediary bank's computing device to the processor of the second country;
the processor of the second country is configured to, in real time separately and before the electronic payment transaction, receive the message, check and validate the data in the message; and transmit it to the computing device of the recipient's bank;
the computing device of the recipient's bank is configured, in real time separately and before the electronic payment transaction, to receive the message, enrich it with data of the recipient, the recipient's bank, confirmation of readiness of the recipient's bank to credit funds, and send the enriched message to the processor of the second country,
wherein the processor of the first country is configured to, in real time separately and before the electronic payment transaction:
receive an enriched message from the processor of the second country via the intermediary bank's computing device,
generate an electronic payment processing identifier that uniquely identifies the message, and
send to the sender's device, via the computing device of the sender's bank, a message with a pre-approved payment order for an electronic payment transaction, and an electronic payment processing identifier for their subsequent use when performing an electronic payment transaction.

4. The system according to claim 3, wherein the computing device of the sender's bank is configured to receive from the sender's device a response to the enriched message; comprising at least
confirmation of readiness to credit funds by the recipient's bank and the payment amount in the first currency and the amount in the second currency after conversion, an electronic payment processing identifier indicating that the funds transfer has been approved and confirmation of transmission of the message to the processor of the first country;
the processor of the first country is configured to receive the enriched message and send to the settlement system of the first country a requirement to debit funds from the account of the sender's bank and credit them to the account of the intermediary bank in the first currency,
the settlement system of the first country is configured to receive the requirement, fulfill the requirement, and send confirmation of the requirement fulfillment via the processor of the first country to the computing device of the sender's bank and the computing device of the intermediary bank;
the computing device of the intermediary bank is configured to receive the confirmation, send a funds transfer request to the processor of the second country;
the processor of the second country is configured to receive the funds transfer request and send to the settlement system of the second country a requirement to debit funds from the account of the intermediary bank in the second currency and credit funds to the account of the recipient's bank in the second currency after conversion;
the settlement system of the second country is configured to receive the requirement, fulfill the requirement, and send confirmation of the requirement fulfillment to the computing device of the intermediary bank and to the computing device of the recipient's bank.

5. The system according to claim 3, wherein an intermediary bank of the first country and an intermediary bank of the second country are included, and
the computing device of the sender's bank is configured to receive from the sender's device a response to the enriched message comprising at least confirmation of readiness to credit funds by the recipient's bank and the payment amount in the first currency and the amount in the second currency after conversion, an electronic payment processing identifier indicating that the funds transfer has been approved and confirmation of transmission of the message to the processor of the first country;
the processor of the first country is configured to receive the enriched message and send a requirement to debit funds from the sender's account and credit them to the account of the intermediary bank of the first country in the first currency;
the settlement system of the first country is configured to receive the requirement, fulfill the requirement, and send confirmation of the requirement fulfillment via the processor of the first country to the computing device of the sender's bank and the computing device of the intermediary bank of the first country connected with the computing device of the intermediary bank of the second country to transfer funds from the account of the intermediary bank of the first country in the first currency to the account of the intermediary bank of the second country in the second currency;
the computing device of the intermediary bank of the second country has a communication channel with the processor of the second country, configured to receive a notification of the transfer of funds, transmit to the settlement system of the second country a requirement to debit funds from the account of the intermediary bank of the second country and credit funds to the account of the recipient's bank in the second currency;
the settlement system of the second country is configured to receive the requirement, fulfill the requirement, and send confirmation of the requirement fulfillment to the computing device of the intermediary bank and to the computing device of the recipient's bank via the processor of the second country.

6. The system according to claim 5, wherein an account of the intermediary bank of the second country is opened with the intermediary bank of the first country (or an account of the intermediary bank of the second country is opened with the intermediary bank of the second country) for funds converting from the first currency to the second currency.

7. The system according to any of claims from 3 to 5, wherein at least one computing device of the intermediary bank has communication channels with the computing device of the sender's bank and/or the recipient's bank and is configured to convert funds from the first currency to the second currency between the sender's bank and at least one intermediary bank or at least one intermediary bank and the recipient's bank.

8. The system according to any of claim 4 or 5, wherein at least one settlement system is configured to fulfill the requirements for each separate transaction via the Faster Payments System (SBP).

9. The system according to claim 3, wherein the processor of the first country and the processor of the second country are configured to store at least one recipient's identifier linked to the recipient's account in a database with the ability to identify the recipient's account by the identifier.

10. The system according to claim 3, wherein at least one processor is configured to assign an electronic payment processing identifier to the message and store it in the database for providing data or part of the data of the message upon request.

11. A method of data pre-processing and validation performed in real time separately and before the electronic payment transaction, initiated on the sender's device,
including the message transmission, verification and supplementing
wherein the method comprises steps carried out in real time separately and before the electronic payment transaction, during which:
the sender's device sends the message containing at least the recipient's identifier and the transfer amount;
the computing device of the sender's bank receives the message and then supplements it with data of the sender's bank and the sender;
the processor receives the message, uses the recipient's identifier to determine the recipient's bank to send the message to the recipient's bank;
the computing device of the recipient's bank receives the message, supplements the said message with the data of the recipient and the recipient's bank, and then sends a response message that includes at least the approved data of the sender's bank, the approved data of the recipient's bank, the transfer amount, the electronic payment processing identifier and confirmation of readiness of the recipient's bank to credit funds to the processor,
wherein, an electronic payment processing identifier, uniquely identifying this message, is generated by the processor, and
the computing device of the sender's bank sends to the sender's device a message with a pre-approved payment order for an electronic payment transaction, and a generated electronic payment processing identifier for their subsequent use when performing an electronic payment transaction.

12. The method according to claim 11 additionally contains the steps wherein the computing device of the sender's bank receives the message comprising at least approved data of the sender's bank, approved data of the recipient's bank, the transfer amount, the electronic payment processing identifier and confirmation of readiness of the recipient's bank to credit funds, and transmits the said message to the processor that generates and sends to the settlement system a requirement to debit funds from the sender's bank account and credit funds to the recipient's bank account, after which confirmation of the requirement fulfillment is sent to the computing device of the sender's bank and to the computing device of the recipient's bank.

13. (canceled)

14. The method according to claim 13 additionally contains the steps wherein the computing device of the sender's bank receives from the sender's device the approved data of the sender's bank, the approved data of the recipient's bank, the transfer amount, the electronic payment processing identifier and confirmation of readiness of the recipient's bank to credit funds, transmits the data to the processor of the first country and a funds transfer requirement comprising confirmation of readiness of the recipient's bank to credit funds and the terms of payment, with at least the amount in the first currency and the amount in the second currency after conversion, and then the processor of the first country transmits the said requirement to the settlement system of the first country, where, based on the mentioned requirement, funds are debited from the sender's account and then credited to the account of the intermediary bank in the first currency, then the intermediary bank transfers funds from the intermediary bank account in the first currency to the intermediary bank account in the second currency, sends the enriched message to the processor of the second country, where a requirement to debit funds from the intermediate bank account in the second currency and credit funds to the account of the recipient's bank in the second currency is generated and sent to the settlement system of the second country and confirmation of the requirement fulfillment is sent to the computing device of the intermediary bank and the computing device of the recipient's bank.

15. The method according to claim 13, additionally contains the steps during which the computing device of the sender's bank receives from the sender's device the approved data of the sender's bank, the approved data of the recipient's bank, the transfer amount, the electronic payment processing identifier and confirmation of readiness of the recipient's bank to credit funds,
the data and the requirement to transfer funds, including confirmation of readiness of the recipient's bank to credit funds and the terms of payment, with at least the amount in the first currency and the amount in the second currency after conversion are transmitted to the processor of the first country; and then the processor of the first country transmits the said requirement to the settlement system of the first country, where, based on the requirement, funds are debited from the sender's account and funds are credited to the account of the intermediary bank of the first country in the first currency,
then the intermediary bank of the first country sends a message about the transfer of funds to the intermediary bank of the second country and then from the intermediary bank of the second country to the processor of the second country, where a requirement to debit funds from the intermediary bank account of the second country and credit funds to the recipient's bank account in the second currency is generated and sent to the settlement system of the second country and sends confirmation of the requirement fulfillment to the computing device of the intermediary bank of the second country and to the computing device of the recipient's bank.

16. The method according to claim 15, wherein funds are transferred in the first currency from the account of the intermediary bank of the first country to the account of the intermediary bank of the second country in the second currency before, during or after the funds transfer.

17. (canceled)

18. The method according to any of claim 14 or 15, wherein at least one settlement system fulfills the requirements for each separate transaction via the Faster Payments System (SBP).

19. The method according to any of claim 14 or 15, wherein the processor of the first country or the processor of the second country stores at least one social identifier of the recipient in advance in a database for identifying the account of the recipient by the social identifier.

20. The method according to claim 13, wherein at least one processor assigns an electronic payment processing identifier to the message and stores it in a database for providing data or part of the data of the message upon request.

21. A method of data pre-processing and validation performed in real time separately and before the electronic payment transaction, initiated on the sender's device, comprises the message transmission, verification and supplementing,
wherein the method comprises steps carried out in real time separately and before the payment transaction, during which:
the sender's device sends the message containing at least the recipient's identifier and the transfer amount;
the computing device of the sender's bank receives the message and then supplements it with data of the sender's bank and the sender;
the message is received by at least one computing device of the intermediary bank, where the buy rate or sell rate of an amount in the first currency into an amount in the second currency is determined and the exchange rate data is stored in the message;
then, the message from the computing device of the intermediary bank's is sent to the computing device of the recipient's bank's;
the computing device of the recipient's bank receives the message, supplements the said message with the data of the recipient and the recipient's bank, and then sends a response message that includes at least the approved data of the sender's bank, the approved data of the recipient's bank, the transfer amount and confirmation of readiness of the recipient's bank to credit funds to at least one computing device of the intermediary bank;
wherein an electronic payment processing identifier, uniquely identifying this message, is generated by the computing device of the intermediary bank, and
the computing device of the sender's bank sends to the sender's device a message with a pre-approved payment order for an electronic payment transaction, and a generated electronic payment processing identifier for their subsequent use when performing an electronic payment transaction.

22. The system according to claim 2, wherein the settlement system is configured to fulfill the requirements for each separate transaction via the Faster Payments System (SBP).

23. The system according to claim 1, wherein the processor is configured to store at least one recipient's identifier linked to the recipient's account in a database with the ability to identify the recipient's account by the identifier.

24. The system according to claim 1, wherein the processor is configured to assign an electronic payment processing identifier to the message and save it in a database to provide data or part of the message data upon request.

25. The method according to claim 12, wherein the settlement system fulfills the requirements for each separate transaction via the Faster Payments System (SBP).

26. The method according to claim 15, wherein the processor stores at least one social identifier of the recipient in advance in a database for identifying the account of the recipient by the social identifier.

27. The method according to claim 14, wherein the processor assigns an electronic payment processing identifier to the message and stores it in a database for providing data or part of the data of the message upon request.

28. A method of data pre-processing and validation performed in real time separately and before the electronic payment transaction, initiated on the sender's device, comprises the message transmission, verification and supplementing,
wherein the method comprises steps carried out in real time separately and before the electronic payment transaction, during which:
the sender's device sends the message containing at least the recipient's identifier and the transfer amount;
the computing device of the sender's bank receives the message and then supplements it with data of the sender's bank;
the processor of the first country receives the message, determines the recipient's bank of the second country using the recipient's identifier, and sends the message to at least one computing device of the intermediary bank to determine the buy rate or sell rate of the amount in the first currency into the amount in the second currency, and stores the exchange rate data in the message;
the computing device of the intermediary bank sends the message to the processor of the second country, then the message is sent to the computing device of the recipient's bank, where the message is supplemented with the data of the recipient, data of the recipient's bank, and the recipient's bank confirms the readiness to credit funds to the recipient's account and sends a response message comprising at least approved data of the sender's bank, approved data of the recipient's bank, the transfer amount, and confirmation of readiness of the recipient's bank to credit funds to the processor of the second country, then to at least one computing device of the intermediary bank, then to the processor of the first country,
wherein, an electronic payment processing identifier, uniquely identifying this message, is generated by the processor of the first country, and
the computing device of the sender's bank sends to the sender's device a message with a pre-approved payment order for an electronic payment transaction, and a generated electronic payment processing identifier for their subsequent use when performing an electronic payment transaction.
